(19) United States
(12) Patent Application Publication
(10) Pub. No.: US 2026/0301592 A1
(43) Pub. Date: Oct. 1, 2026

(54) APPARATUS AND METHOD OF PROVIDING BLOODSTAIN PATTERN ANALYSIS TRAINING USING VIRTUAL REALITY

(71) Applicant: REPUBLIC OF KOREA (NATIONAL FORENSIC SERVICE DIRECTOR MINISTRY OF THE INTERIOR AND SAFETY), Wonju-si (KR)

(72) Inventors: Young Il SEO, Wonju-si (KR); Jae Hyeok YI, Wonju-si (KR)

(21) Appl. No.: 19/262,649

(22) Filed: Jul. 8, 2025

(30) Foreign Application Priority Data
Mar. 28, 2025 (KR) 10-2025-0040456

(51) Int. Cl. G09B 5/02; G06F 3/04845; G06T 17/00; G06V 10/764

(52) U.S. Cl. CPC G09B 5/02; G06F 3/04845; G06T 17/00; G06V 10/764

(57) ABSTRACT

An apparatus of providing bloodstain pattern analysis training using virtual reality according to an embodiment includes: at least one memory storing at least one instruction; and at least one processor, wherein the at least one processor is configured to execute the at least one instruction to: transmit and output a virtual crime scene video based on a virtual bloodshed incident scenario to a first electronic device; receive a bloodstain pattern analysis report of a virtual crime scene prepared by a trainee through a second electronic device; and compare the bloodstain pattern analysis report with the virtual bloodshed incident scenario and transmit feedback to the second electronic device.

### CROSS-REFERENCE TO RELATED APPLICATIONS

The present application is based on and claims priority to Korean Patent Application No. 10-2025-0040456, filed on Mar. 28, 2025, in the Korean Intellectual Property Office, which is incorporated herein by reference in its entirety.

### BACKGROUND

### 1. Field

One or more embodiments relate to an apparatus and a method of providing bloodstain pattern analysis training using virtual reality.

### 2. Description of the Related Art

In criminal cases, bloodstain pattern analysis (BPA) plays an important role in reconstructing the scene of a bloody incident and understanding the crime scene.

Bloodstain pattern analysis is conducted according to a methodology that includes distinguishing and observing bloodstain patterns, classifying bloodstain patterns, analyzing the dynamics of the bloodstains, and inferring and reconstructing actions based on the bloodstains. Inferring human behavior through bloodstain pattern analysis requires substantial experience and specialized forensic expertise.

When performing bloodstain pattern analysis, it is difficult to accurately analyze newly discovered bloodstain patterns at crime scenes using only existing literature or paper studies. Therefore, for field analysis, a field investigation training technique that simulates an actual crime scene is required.

The training technique currently in use involves creating a mock crime scene, generating target bloodstains in a physical training space, and having the trainee practice on them. However, this method has several issues, including difficulty in securing space for the mock scene, limited resemblance to an actual crime scene, lack of diversity in training environments, and challenges in cleaning up bloodstains after practice.

With the recent rapid development of virtual reality (VR) technology, its application may offer training effects similar to those achieved in a realistic field investigation setting.

### SUMMARY

One or more embodiments include an apparatus and a method of providing bloodstain pattern analysis training using virtual reality capable of reproducing a variety of realistic virtual crime scenes using virtual reality technology, thereby improving field investigation capabilities of bloodstain pattern analysis trainees.

According to one or more embodiments, an apparatus of providing bloodstain pattern analysis training using virtual reality includes: at least one memory storing at least one instruction; and at least one processor, wherein the at least one processor is configured to execute the at least one instruction to: transmit and output a virtual crime scene video based on a virtual bloodshed incident scenario to a first electronic device; receive a bloodstain pattern analysis report of a virtual crime scene prepared by a trainee through a second electronic device; and compare the bloodstain pattern analysis report with the virtual bloodshed incident scenario and transmit feedback to the second electronic device.

In an embodiment, the virtual crime scene video may be generated based on an actual crime scene 3D scan image or a virtual crime scene 3D modeling image.

In an embodiment, the virtual crime scene video may include a bloodstain image placed on at least one of a wall, floor, and object of the virtual crime scene.

In an embodiment, the bloodstain image may be selected or generated based on a morphological classification system of bloodstains.

In an embodiment, the morphological classification system of bloodstains may include: first classification, which classifies a bloodstain into a spatter stain and a non-spatter stain according to bloodstain pattern features; second classification, which classifies the spatter stain into a linear spatter and a non-linear spatter according to whether bloodstains are distributed linearly, and classifies the non-spatter stain into an irregular margin and regular margin according to whether the margins are regular; third classification, which classifies the linear spatter into a spurt, swing cast-off pattern, drip trail, and cessation cast-off pattern (linear), classifies the non-linear spatter into a non-drip and a drip based on the presence or absence of radial distribution, wherein the non-drip is classified into an expectorate spatter and a non-expectorate spatter based on the presence or absence of small rings and bubbles, wherein the non-expectorate spatter is classified into an impact spatter stain and a cessation cast-off pattern (non-linear) based on the presence or absence of circular or oval bloodstains, classifies the irregular margin into a smear and a non-smear based on the presence or absence of a spatter stain or spine, wherein the non-smear is classified into “blood into blood”, a gush, and a splash pattern, and the smear is classified into a wipe pattern and a swipe pattern based on the presence or absence of a pre-existing bloodstain, and classifies the regular margin into a pattern transfer, saturation stain, flow pattern, pool, and irregular pattern transfer; and fourth classification, which classifies the spurt into a wrist spurt and a carotid spurt, classifies the impact spatter stain into a blunt impact spatter stain and a gun impact spatter stain, and classifies the cessation cast-off pattern (non-linear) into a forward cessation cast-off pattern and a back cessation cast-off pattern.

In an embodiment, the at least one processor may be configured to execute the at least one instruction to: receive the trainee's input for zooming in or out on bloodstains and adjusting their brightness in the virtual crime scene video through the third electronic device, and output a re-rendered video to the first electronic device.

In an embodiment, the first electronic device, the second electronic device, and the third electronic device may be implemented as identical devices, as different devices, or two of these devices may be combined to implement as one device.

In an embodiment, the feedback may include at least one of an accuracy assessment of the bloodstain pattern analysis report, missing information, or improvements.

According to one or more embodiments, a method of providing bloodstain pattern analysis training using virtual reality includes: transmitting and outputting a virtual crime scene video based on a virtual bloodshed incident scenario to a first electronic device; receiving a bloodstain pattern analysis report of a virtual crime scene prepared by a trainee through a second electronic device; and comparing the bloodstain pattern analysis report with the virtual bloodshed incident scenario and transmitting feedback to the second electronic device.

In an embodiment, the method may include: receiving the trainee's input for enlarging or reducing of a bloodstain and adjusting bloodstain brightness in the virtual crime scene video through the third electronic device, and outputting a re-rendered video to the first electronic device.

A non-transitory computer-readable recording medium having recorded thereon a computer program according to an embodiment may execute a bloodstain pattern analysis training method using virtual reality by using a computer.

Additional aspects will be set forth in part in the description which follows and, in part, will be apparent from the description, or may be learned by practice of the embodiments.

### BRIEF DESCRIPTION OF THE DRAWINGS

These and/or other aspects will become apparent and more readily appreciated from the following description of the embodiments, taken in conjunction with the accompanying drawings in which:

FIG. 1 is a schematic view of a bloodstain pattern analysis training providing system using virtual reality, according to an embodiment;

FIG. 2 is a configuration diagram of an apparatus of providing bloodstain pattern analysis training using virtual reality, according to an embodiment;

FIGS. 3 and 4 are flowcharts illustrating bloodstain pattern analysis training methods using virtual reality, according to embodiments;

FIG. 5 is a view of a morphological classification system of bloodstains; and

FIG. 6 is an exemplary view of a scene of a virtual crime scene video based on a virtual bloodshed incident scenario.

### DETAILED DESCRIPTION

Hereinafter, embodiments will be described in detail with reference to the accompanying drawings. The same reference numerals are used to denote the same elements, and repeated descriptions thereof will be omitted.

It will be understood that although the terms “first,” “second,” etc. may be used herein to describe various elements, these elements should not be limited by these terms.

An expression used in the singular encompasses the expression of the plural, unless it has a clearly different meaning in the context.

It will be further understood that the terms “comprises” and/or “comprising” used herein specify the presence of stated features or components, but do not preclude the presence or addition of one or more other features or components.

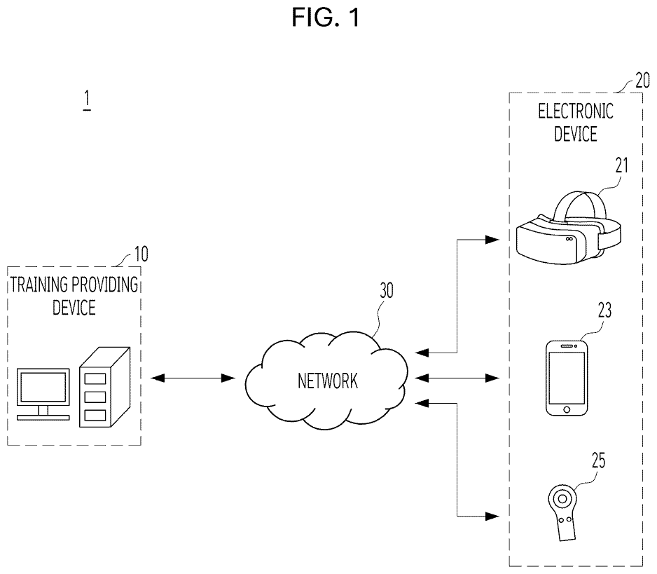

FIG. 1 is a schematic view of a bloodstain pattern analysis training providing system using virtual reality, according to an embodiment.

Referring to FIG. 1, a bloodstain pattern analysis training providing system 1 using virtual reality according to an embodiment may include a bloodstain pattern analysis training providing device 10 (hereinafter, training providing device 10), an electronic device 20, and a network 30 connecting them.

The bloodstain pattern analysis training providing system 1 using virtual reality according to an embodiment provides a service for bloodstain pattern analysis training.

A user using the bloodstain pattern analysis training providing system 1 may include a trainer who provides bloodstain pattern analysis training and a trainee who performs the bloodstain pattern analysis training.

The trainee prepares a bloodstain pattern analysis report using a crime scene video using virtual reality and receives feedback on it. Therefore, the bloodstain pattern analysis training providing system 1 using virtual reality according to an embodiment provides the trainee with training to perform bloodstain pattern analysis for various bloodstain patterns that can be found at various crime scenes.

In more detail, the bloodstain pattern analysis training providing system 1 provided according to an embodiment may allow a user to upload data obtained by a bloodstain pattern analysis training method and share the uploaded data with other users. For example, a user may upload data about various virtual crime scene videos used for training and bloodstain images or bloodstain generation images used for training. The bloodstain pattern analysis training providing system 1 according to an embodiment may register data uploaded by a user in the training providing device 10 and provide an interface through which other users may view the data registered in the training providing device 10. The bloodstain pattern analysis training providing system 1 according to an embodiment may build a database of data about various virtual crime scene videos and multiple bloodstain images that can be found at a crime scene.

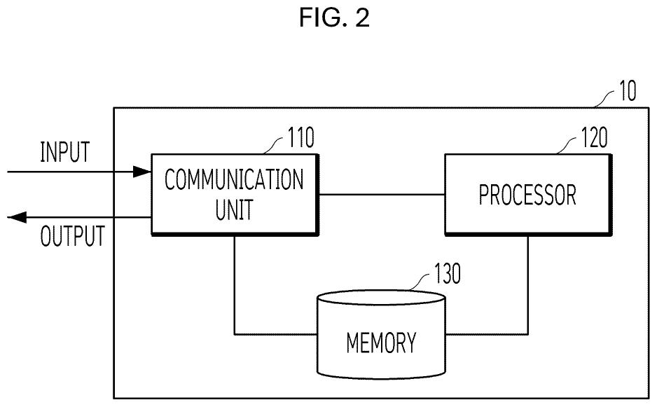

FIG. 2 is a configuration diagram of an apparatus of providing bloodstain pattern analysis training using virtual reality, according to an embodiment.

Referring to FIG. 2, the training providing device 10 may include a communication unit 110, a processor 120, and a memory 130. The training providing device 10 to which the disclosure is applied may be an information processing device used by a user. However, the disclosure is not limited thereto, and the training providing device 10 may further include other components or some components may be omitted.

The training providing device 10 may include a computer, a server device, and a portable terminal, and may be implemented in the form of any one of these.

The communication unit 110 is connected to the processor 120 and the memory 130 to transmit and receive data. The communication unit 110 may be connected to another external device to transmit and receive data. Hereinafter, the expression “transmitting and receiving A” may indicate transmitting and receiving “information or data representing A.”

The communication unit 110 may be implemented as circuitry within the training providing device 10. For example, the communication unit 110 may include an internal bus and an external bus. As another example, the communication unit 110 may be an element that connects the training providing device 10 to an external device. The communication unit 110 may be an interface. The communication unit 110 may receive data from an external device and transmit the data to the processor 120 and the memory 130.

The processor 120 may control operations of the training providing device 10 and perform logical operations.

The processor 120 processes data received by the communication unit 110 and data stored in the memory 130. The processor 120 may be a data processing device implemented in hardware having a circuit with a physical structure for performing desired operations. For example, desired operations may include code or instructions included in a program.

The processor 120 executes computer-readable code (e.g., software) stored in a memory (e.g., the memory 130) and instructions triggered by the processor 120.

The processor 120 controls the execution of a desired operation by executing at least one instruction stored in the memory 130. The at least one instruction may be stored in an internal memory included in the processor 120 or in the memory 130 included in a data processing device separately from the processor 120.

For example, the processor 120 may perform the following operations 210 to 250, which will be described in detail later.

The memory 130 stores data received by the communication unit 110 and data processed by the processor 120. The memory 130 may store a program (or application or software) that operates the training providing device 10. The stored program may be coded to control the training providing device 10 and may be executable by the processor 120.

The memory 130 may include a volatile memory such as static RAM (SRAM), dynamic RAM (DRAM) or synchronous DRAM (SDRAM), or a non-volatile memory such as a flash memory, phase-change RAM (PRAM), magnetic RAM (MRAM), resistive RAM (RRAM) or ferroelectric RAM (FRAM).

The training providing device 10 according to an embodiment may include an artificial intelligence (AI) model. The AI model may be one AI model, or may be implemented as multiple AI models. Artificial intelligence is a technology that learns based on a large amount of data and performs predictions or determinations on specific tasks. The AI model used in the disclosure may include, for example, a deep neural network, and may be executed by at least one processor 120 to perform predictions or determinations. In more detail, the processor 120 processes input data by executing code of the AI model and outputs results.

The electronic device 20 may be connected to the training providing device 10 through the network 30. For example, the electronic device 20 may include a first electronic device 21, a second electronic device 23, and a third electronic device 25.

As an embodiment, the first electronic device 21, the second electronic device 23, and the third electronic device 25 may be implemented as identical devices.

At this time, the electronic device 20 may be various types of information processing devices used by a trainee. For example, the electronic device 20 that can be implemented with identical devices may be a personal computer (PC), a laptop computer, a mobile phone, a tablet PC, a smart phone, or a personal digital assistant (PDA). However, these are only examples, and in addition to the examples described above, the electronic device 20 needs to be interpreted as a concept including all devices capable of communication that are currently developed and commercialized or to be developed in the future.

As another embodiment, the first electronic device 21, the second electronic device 23, and the third electronic device 25 may be implemented as different devices. The first electronic device 21, the second electronic device 23, and the third electronic device 25 may be a PC, a laptop computer, a mobile phone, a tablet PC, a smart phone, a PDA, a smart phone, a wearable display device, a virtual reality (VR) device, a wearable device, a VR controller, a game console, etc.

In addition, two devices among the first electronic device 21, the second electronic device 23, and the third electronic device 25 may be combined to be implemented as one device.

The network 30 serves to connect the training providing device 10 and the electronic device 20. For example, the network 30 provides a connection path so that the electronic device 20 may transmit and receive packet data after being connected to the training providing device 10.

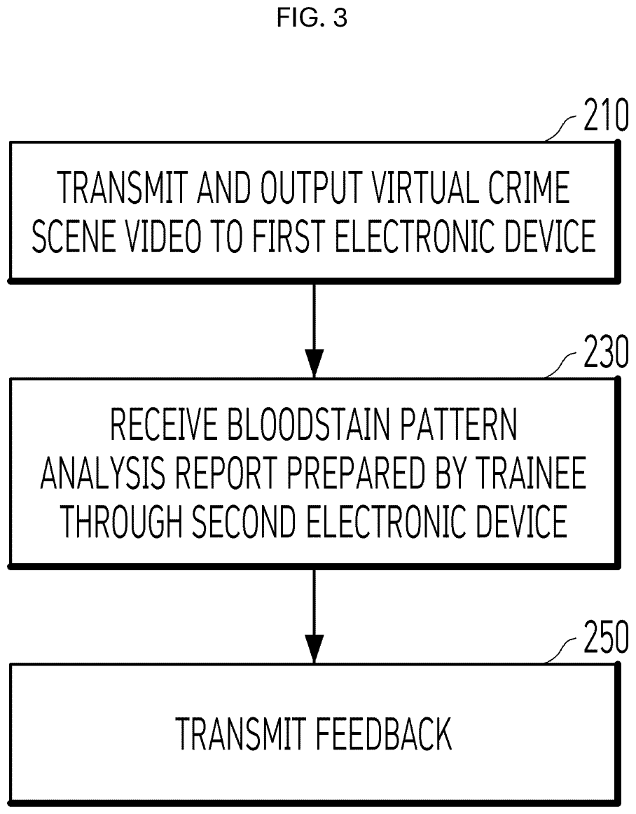

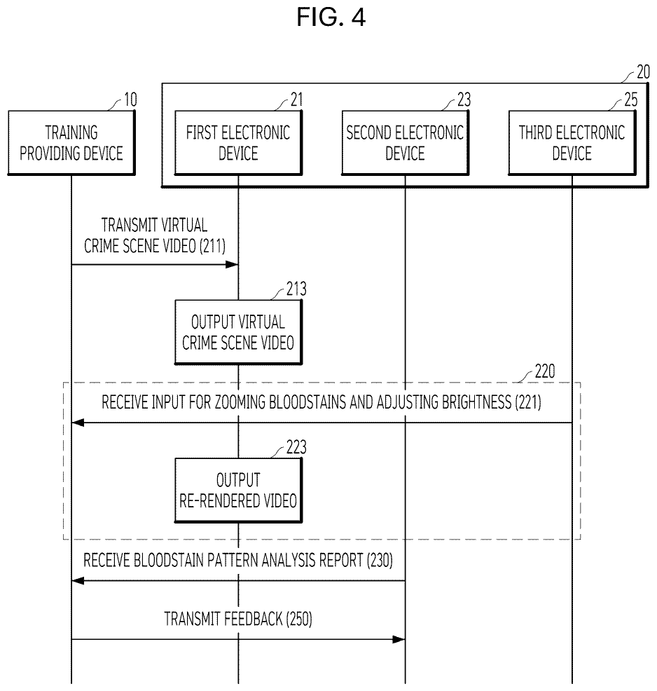

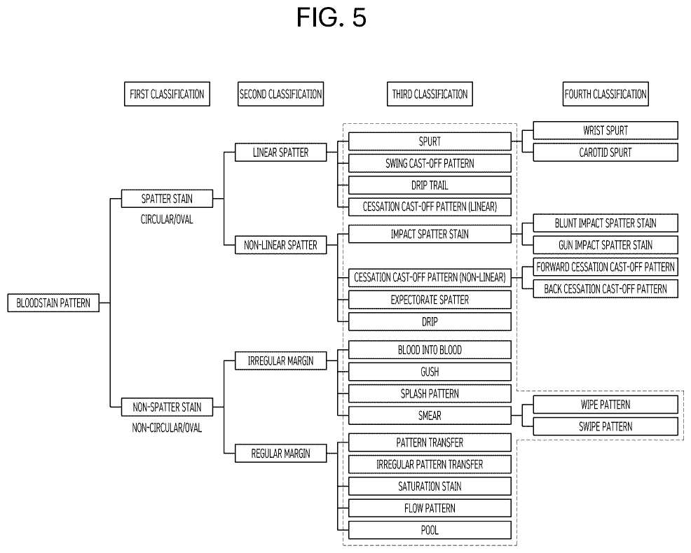

FIGS. 3 and 4 are flowcharts illustrating bloodstain pattern analysis training methods using virtual reality, according to embodiments. FIG. 5 is a view of a morphological classification system of bloodstains.

Hereinafter, a bloodstain pattern analysis training method using virtual reality according to an embodiment will be described with reference to FIGS. 3 to 5.

The following operations 210 to 250 may be performed by the training providing device 10.

In operation 210, the training providing device 10 may transmit (operation 211) and output (operation 213) a virtual crime scene video based on a virtual bloodshed incident scenario to the first electronic device 21.

For example, the virtual bloodshed incident scenario may include various scenarios such as a hotel room murder, a crime inside a vehicle, etc. The virtual bloodshed incident scenario may include a variety of crime types, including stabbings, shootings, and violent incidents.

The virtual crime scene video may be generated based on an actual crime scene 3D scan image or a virtual crime scene 3D modeling image. The virtual crime scene video based on the virtual crime scene 3D modeling image may be generated using a 3D drawing program (e.g., Faro Zone 3D, SketchUp, etc.).

The virtual crime scene video may include a bloodstain image placed on at least one of a wall, floor, and object of the virtual crime scene.

The bloodstain image may be selected or generated based on the morphological classification system of bloodstains shown in FIG. 5.

Referring to FIG. 5, the morphological classification system of bloodstains may include the following first classification, second classification, third classification, and fourth classification.

The first classification may classify a bloodstain into a spatter stain and a non-spatter stain according to bloodstain pattern features.

The second classification is subclassification of the first classification and is as follows:

The spatter stain may be classified into a linear spatter and a non-linear spatter according to whether bloodstains are distributed linearly. The non-spatter stain may be classified into an irregular margin and regular margin according to whether the margins are regular.

The second classification is subclassification of the first classification and is as follows:

The linear spatter may be classified into a spurt, swing cast-off pattern, drip trail, and cessation cast-off pattern (linear).

The non-linear spatter may be classified into a non-drip and a drip based on the presence or absence of radial distribution. The non-drip may be classified into an expectorate spatter and a non-expectorate spatter based on the presence or absence of small rings and bubbles. The non-expectorate spatter may be classified into an impact spatter stain and a cessation cast-off pattern (non-linear) based on the presence or absence of circular or oval bloodstains.

The irregular margin may be classified into a smear and a non-smear based on the presence or absence of a spatter stain or spine. The non-smear may be classified into “blood into blood”, a gush, and a splash pattern. The smear may be classified into a wipe pattern and a swipe pattern based on the presence or absence of a pre-existing bloodstain.

The regular margin may be classified into a pattern transfer, saturation stain, flow pattern, pool, and irregular pattern transfer.

The fourth classification is subclassification of the third classification and is as follows:

The spurt may be classified into a wrist spurt and a carotid spurt. The impact spatter stain may be classified into a blunt impact spatter stain and a gun impact spatter stain. The cessation cast-off pattern (non-linear) may be classified into a forward cessation cast-off pattern and a back cessation cast-off pattern.

Unclassified bloodstains that are not classified by the above classification systems include capillary action stains, blood clots, perimeter stains, voids, fly spots, ricochet stains, and altered stains.

The bloodstain image may be selected or generated based on the morphological classification system of bloodstains. In more detail, the bloodstain image may include a real image captured by a camera at an actual crime scene, a scanned document image, a bloodstain image reproduced in experiments, and a bloodstain image generated using artificial neural network technology.

In addition, the first electronic device 21 to which the virtual crime scene video is transmitted may be a wearable display device. The wearable display device is a device that a trainee can wear to receive visual information. For example, the wearable display device may include a head-mounted display (HMD), smart glasses, an XR device, etc. that include virtual reality (VR), augmented reality (AR), and mixed reality (MR) functions.

The trainee may view the virtual crime scene video output through the first electronic device 21. The trainee may freely move around the virtual crime scene space, find a bloodstain, observe the bloodstain found, and perform bloodstain pattern analysis.

At this time, in operation 220, the training providing device 10 may additionally receive (operation 221) the trainee's input for zooming in or out on bloodstains and adjusting their brightness in the virtual crime scene video through the third electronic device 25, and output (operation 223) a re-rendered video to the first electronic device 21.

For example, the third electronic device 25 may be an input device. The input device is a device that detects the user's motion and converts it into a digital signal. For example, the input device may include a VR controller, a motion controller, a haptic feedback controller, a gesture recognition device, etc.

The trainee may observe bloodstains in the virtual crime scene space by zooming in and out on them using the third electronic device 25. In addition, the trainee may use the third electronic device 25 to adjust their brightness by illuminating them, making them appear clearer or darker.

Through operation 220, the trainee may observe the bloodstain precisely and effectively perform bloodstain pattern analysis.

In operation 230, the training providing device 10 may receive a bloodstain pattern analysis report of a virtual crime scene prepared by the trainee through the second electronic device 23.

For example, the second electronic device 23 may be a computing device. The computing device is a device capable of processing data and executing software. For example, the computing device may include smartphones, tablets, laptops, desktop computers, and other electronic terminals.

As an embodiment, the trainee may prepare a bloodstain pattern analysis report using dedicated software running on the second electronic device 23. As another embodiment, the trainee may manually prepare the report and save the result as a PDF file or similar format on the second electronic device 23.

For example, the bloodstain pattern analysis report may include analysis results for bloodstain pattern, bloodstain distribution and direction, and scene reconstruction.

In operation 250, the training providing device 10 may compare the bloodstain pattern analysis report with a virtual bloodshed incident scenario and transmit feedback to the second electronic device 23.

The feedback may include at least one of an accuracy assessment of the bloodstain pattern analysis report, missing information, or improvements.

Hereinafter, a bloodstain pattern analysis report created by a training method according to an embodiment and feedback therefor will be exemplarily described.

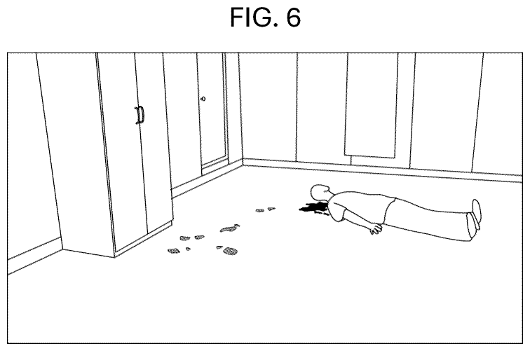

FIG. 6 is an exemplary view of a scene of a virtual crime scene video based on a virtual bloodshed incident scenario. Referring to FIG. 6, a victim was found lying flat on the floor, with blood pooling around his head. There are shoe prints scattered on the floor, showing bloodstains.

A trainee wears an HMD and enters the virtual crime scene to observe the scene and the bloodstain pattern. The trainee may use a VR controller to zoom in on a bloodstain or illuminate it to better observe and analyze the bloodstain pattern. The trainee may use an electronic terminal to analyze the virtual crime scene with dedicated software and create a bloodstain pattern analysis report.

Table 1 is an example of a bloodstain pattern analysis report, listing analysis items and their corresponding analysis results.

TABLE 1

| Analysis items | Analysis results |
|---|---|
| Observation of | Around the victim's head: A pool has formed, which appears |
| bloodstain patterns | to have been caused by continued bleeding. |
| | Footprints on the floor: Pattern transfers formed by bloody |
| | shoes has been observed. The footprints indicate a moving |
| | path at the scene. |
| | Around the footprints: Scattered small stains of “blood into |
| | blood” pattern, likely formed by repeated dripping of blood |
| | during movement. |
| Bloodstain | The footprints appear to start near the victim's head and |
| distribution and | move to the right. |
| direction | The size and shape of the footprints suggest they were likely |
| | made by one person's shoes. |
| Conclusion | The victim fell to the floor after being hit in the head, and it is |
| | determined that there was continuous bleeding near the head. |
| | The perpetrator clearly observed moving around the scene |
| | with bloody shoes. This could be an important clue in tracking |
| | the perpetrator's moving path. |
| | The distribution of footprints and “blood into blood” pattern |
| | can be used to reconstruct the movement and actions at the |
| | time of the incident. |

Referring to Table 1, a pool of blood around the victim's head, pattern transfers formed by bloody shoes, and “blood into blood” patterns scattered around footprints may be observed at a virtual crime scene. In addition, distribution and direction of the bloodstains may be determined, and the crime case may be reconstructed based on the conclusion. A bloodstain pattern analysis report including such contents may be prepared by a trainee and transmitted to the training providing device 10 through his or her electronic terminal. The training providing device 10 may compare the virtual bloodshed incident scenario with the bloodstain pattern analysis report and transmit feedback.

Tables 2 and 3 show examples of feedback for the bloodstain pattern analysis report of Table 1.

A trainee may receive feedback such as Tables 2 and 3 from the training providing device 10 through his or her electronic terminal. The training providing device 10 may transmit feedback input by artificial intelligence or a trainer through the electronic terminal.

TABLE 2

| | | | | Usefulness of | |
|---|---|---|---|---|---|
| Bloodstain | Classification | Interpretation | Data | additional | Total Score |
| patterns | accuracy | accuracy | usability | analysis | (out of 10) |
| Pool | 10 | 9 | 9 | 8 | 9 |
| Pattern | 9 | 8 | 9 | 7 | 8.5 |
| transfer | | | | | |
| Blood into | 8 | 7 | 8 | 6 | 7.25 |
| Blood | | | | | |

Table 2 presents results of evaluations based on evaluation items for each bloodstain pattern discovered by a trainee at a virtual crime scene.

TABLE 3

| Missing | |
|---|---|
| bloodstains | Contents |
| (Blunt) impact | Probability: A pattern of blood spatter that may occur when the |
| spatter stain | head is struck. This may appear as small blood droplets on the walls |
| | or floor around the victim's head. |
| | Analytical value: By analyzing the distribution and pattern of (blunt) |
| | impact spatter stains, the intensity and angle of impact at the time of |
| | strike, and the location of the perpetrator may be estimated. |
| Wipe pattern | Probability: This may occur when the perpetrator attempts to wipe |
| | bloodstains after the crime. This is a faint or smeared bloodstain that |
| | occurs when wiping a surface that has blood on it. |
| | Analytical value: The presence of wipe pattern suggests that the |
| | perpetrator attempted to destroy evidence, and the direction and |
| | extent of the wipe pattern may help estimate the perpetrator's |
| | actions. |
| Drip trail | Probability: A continuous pattern of blood drops shed by the |
| | perpetrator as he or she flees after committing a crime. |
| | Analytical value: The drip trail provides important clues in tracking |
| | the perpetrator's moving path and may help estimate the extent of |
| | injuries or speed of movement. |

Table 3 presents additional bloodstain patterns that may occur at a crime scene, such as a (blunt) impact spatter stain, wipe pattern, and drip trail, in addition to the bloodstain patterns identified in Table 1, and includes an explanation of the possibility of occurrence of each bloodstain pattern.

In the disclosure, a bloodstain pattern or location may be changed in a specific virtual crime scene. In addition, the bloodstain pattern may be changed according to the change of the virtual crime scene. Furthermore, the difficulty of training may be adjusted by placing bloodstains that are easy to identify according to the trainee's level of forensic science. These bloodstain changes may be performed by a trainee or artificial intelligence.

The bloodstain pattern analysis training methods using virtual reality according to various embodiments illustrated in FIGS. 3 and 4 can be written as computer programs and can be implemented in general-use digital computers that execute the programs using a non-transitory computer-readable recording medium. The non-transitory computer-readable recording medium may be a magnetic storage medium (e.g., read-only memory (ROM), a floppy disk, a hard disk, etc.), or an optical reading medium (e.g., a CD ROM, a digital versatile disk (DVD) or the like).

Embodiments may reproduce various virtual scenes resemble real crime scenes using virtual reality technology. This allows bloodstain pattern analysis trainees to practice repeatedly in a risk-free environment and to learn realistic forensic procedures applicable to crime scene investigations.

Furthermore, embodiments may enhance the field investigation capabilities of trainees, thereby effectively contributing to the investigation and reconstruction of bloodshed incidents.

The description herein is for describing the disclosure and numerous modifications and adaptations will be readily apparent to one of ordinary skill in the art without departing from the spirit and scope of the disclosure. For example, the relevant results may be achieved even when the described technologies are performed in a different order than the described methods, and/or even when the described elements such as systems, structures, devices, and circuits are coupled or combined in a different form than the described methods or are replaced or substituted by other elements or equivalents.

Accordingly, while the disclosure has been particularly shown and described with reference to embodiments thereof, it will be understood that various changes in form and details may be made therein without departing from the spirit and scope of the following claims.

What is claimed is:

1. An apparatus of providing bloodstain pattern analysis training using virtual reality, the apparatus comprising:
at least one memory storing at least one instruction; and
at least one processor,
wherein the at least one processor is configured to execute the at least one instruction to:
transmit and output a virtual crime scene video based on a virtual bloodshed incident scenario to a first electronic device;
receive a bloodstain pattern analysis report of a virtual crime scene prepared by a trainee through a second electronic device; and
compare the bloodstain pattern analysis report with the virtual bloodshed incident scenario and transmit feedback to the second electronic device.

2. The apparatus of claim 1, wherein the virtual crime scene video is generated based on an actual crime scene 3D scan image or a virtual crime scene 3D modeling image.

3. The apparatus of claim 1, wherein the virtual crime scene video comprises a bloodstain image placed on at least one of a wall, floor, and object of the virtual crime scene.

4. The apparatus of claim 3, wherein the bloodstain image is selected or generated based on a morphological classification system of bloodstains.

5. The apparatus of claim 4, wherein the morphological classification system of bloodstains comprises:
first classification, which classifies a bloodstain into a spatter stain and a non-spatter stain according to bloodstain pattern features;
second classification, which classifies the spatter stain into a linear spatter and a non-linear spatter according to whether bloodstains are distributed linearly, and classifies the non-spatter stain into an irregular margin and a regular margin according to whether the margins are regular;
third classification, which classifies the linear spatter into a spurt, swing cast-off pattern, drip trail, and cessation cast-off pattern (linear),
classifies the non-linear spatter into a non-drip and a drip based on the presence or absence of radial distribution, wherein the non-drip is classified into an expectorate spatter and a non-expectorate spatter based on the presence or absence of small rings and bubbles, wherein the non-expectorate spatter is classified into an impact spatter stain and a cessation cast-off pattern (non-linear) based on the presence or absence of circular or oval bloodstains,
classifies the irregular margin into a smear and a non-smear based on the presence or absence of a spatter stain or spine, wherein the non-smear is classified into blood into blood, a gush, and a splash pattern, and the smear is classified into a wipe pattern and a swipe pattern based on the presence or absence of a pre-existing bloodstain, and
classifies the regular margin into a pattern transfer, saturation stain, flow pattern, pool, and irregular pattern transfer; and
fourth classification, which classifies the spurt into a wrist spurt and a carotid spurt, classifies the impact spatter stain into a blunt impact spatter stain and a gun impact spatter stain, and classifies the cessation cast-off pattern (non-linear) into a forward cessation cast-off pattern and a back cessation cast-off pattern.

6. The apparatus of claim 1, wherein the at least one processor is configured to execute the at least one instruction to:
receive trainee's input for zooming in or out on bloodstains and adjusting their brightness in the virtual crime scene video through the third electronic device, and output a re-rendered video to the first electronic device.

7. The apparatus of claim 6, wherein the first electronic device, the second electronic device, and the third electronic device are implemented as identical devices, as different devices, or two of these devices are combined to implement as one device.

8. The apparatus of claim 1, wherein the feedback comprises at least one of an accuracy assessment of the bloodstain pattern analysis report, missing information, or improvements.

9. A bloodstain pattern analysis training method using virtual reality comprising:
transmitting and outputting a virtual crime scene video based on a virtual bloodshed incident scenario to a first electronic device;
receiving a bloodstain pattern analysis report of a virtual crime scene prepared by a trainee through a second electronic device; and
comparing the bloodstain pattern analysis report with the virtual bloodshed incident scenario and transmitting feedback to the second electronic device.

10. The bloodstain pattern analysis training method using virtual reality of claim 9 comprising:
receiving the trainee's input for zooming in or out on bloodstains and adjusting their brightness in the virtual crime scene video through the third electronic device, and outputting a re-rendered video to the first electronic device.

11. The bloodstain pattern analysis training method using virtual reality of claim 9, wherein the virtual crime scene video comprises a bloodstain image placed on at least one of a wall, floor, and object of the virtual crime scene.

12. The bloodstain pattern analysis training method using virtual reality of claim 11, wherein the bloodstain image is selected or generated based on a morphological classification system of bloodstains.

13. The bloodstain pattern analysis training method using virtual reality of claim 12, wherein the morphological classification system of bloodstains comprises:
first classification, which classifies a bloodstain into a spatter stain and a non-spatter stain according to bloodstain pattern features;
second classification, which classifies the spatter stain into a linear spatter and a non-linear spatter according to whether bloodstains are distributed linearly, and classifies the non-spatter stain into an irregular margin and a regular margin according to whether the margins are regular;
third classification, which classifies the linear spatter into a spurt, swing cast-off pattern, drip trail, and cessation cast-off pattern (linear),
classifies the non-linear spatter into a non-drip and a drip based on the presence or absence of radial distribution, wherein the non-drip is classified into an expectorate spatter and a non-expectorate spatter based on the presence or absence of small rings and bubbles, wherein the non-expectorate spatter is classified into an impact spatter stain and a cessation cast-off pattern (non-linear) based on the presence or absence of circular or oval bloodstains,
classifies the irregular margin into a smear and a non-smear based on the presence or absence of a spatter stain or spine, wherein the non-smear is classified into blood into blood, a gush, and a splash pattern, and the smear is classified into a wipe pattern and a swipe pattern based on the presence or absence of a pre-existing bloodstain, and
classifies the regular margin into a pattern transfer, saturation stain, flow pattern, pool, and irregular pattern transfer; and
fourth classification, which classifies the spurt into a wrist spurt and a carotid spurt, classifies the impact spatter stain into a blunt impact spatter stain and a gun impact spatter stain, and classifies the cessation cast-off pattern (non-linear) into a forward cessation cast-off pattern and a back cessation cast-off pattern.

14. A computer program stored on a non-transitory computer-readable storage medium for executing the method of claim 9 using a computer.
